(19) United States
(12) Patent Application Publication
(10) Pub. No.: US 2015/0171414 A1
(43) Pub. Date: Jun. 18, 2015

(54) LITHIUM SECONDARY BATTERY AND METHOD FOR PRODUCING SAME

(71) Applicants: Koji Takahata, Toyota-shi (JP); Kaoru Inoue, Hirakata-shi (JP)

(72) Inventors: Koji Takahata, Toyota-shi (JP); Kaoru Inoue, Hirakata-shi (JP)

(21) Appl. No.: 14/361,721

(22) PCT Filed: Dec. 2, 2011
(86) PCT No.: PCT/JP2011/077961

§ 371 Date: Sep. 29, 2014

(51) Int. Cl. H01M 4/04; H01M 10/0525; H01M 4/62; H01M 4/64; H01M 4/587

(52) U.S. Cl. CPC H01M 4/0404; H01M 4/64; H01M 4/587; H01M 4/622; H01M 10/0525; H01M 2220/20

(57) ABSTRACT

A method is provided for manufacturing a lithium secondary battery, wherein a negative electrode composite material layer formed on a negative electrode in this battery has a maximum point, in accordance with measurement of the pore distribution based on a mercury intrusion technique, in the pore diameter range (A) of from at least 0.3 μm to not more than 4 μm and in the pore diameter range (B) of from at least 0 μm to less than 0.3 μm, and has a ratio (V_{A}/V_{B}) between the pore volume (V_{A}) at the maximum point in the range A and the pore volume (V_{B}) at the maximum point in the range B of from at least 2.1 to not more than 3.4.

### TECHNICAL FIELD

The present invention relates to a lithium secondary battery. More particularly, the present invention relates to such a battery that exhibits an excellent capacity retention property in high-temperature environment and to a method for manufacturing this battery.

### BACKGROUND ART

Lithium ion batteries and other lithium secondary batteries are smaller and lighter and have a higher energy density than older batteries and exhibit an excellent power density. As a consequence, they have in recent years come to be preferentially used as vehicle drive power sources and as so-called portable power sources for, e.g., personal computers and mobile and portable electronic devices.

Lithium secondary batteries (typically lithium ion batteries) of this type are provided with a structure in which an electrolyte (typically an electrolyte solution) and an electrode assembly having a positive electrode and a negative electrode are housed in a battery case. For each of these electrodes (positive electrode and negative electrode), an electrode composite material layer (specifically, a positive electrode composite material layer or a negative electrode composite material layer)—in which the main component is an active material capable of the reversible insertion and extraction of the charge carrier (typically the lithium ion)—is formed on the corresponding positive electrode current collector or negative electrode current collector.

When a lithium secondary battery is used as a so-called portable power supply, a small size, low weight, and higher energy density (capacity) are preferred for such a battery as noted above. However, when the density within the electrode composite material layer is raised in order to obtain a higher energy density, the diffusion resistance for the charge carrier within the composite material layer undergoes an increase and the power density and durability (cycle characteristics) may then degrade. Patent Literature 1, Patent Literature 2, and Patent Literature 3 are examples of conventional art to counter this problem. For example, Patent Literature 1 discloses an art in which the power density can be raised by securing a favorable pore distribution within the negative electrode composite material layer.

### CITATION LIST

### Patent Literature

Patent Literature 1: Japanese Patent Application Laid-open No. H09-129232

Patent Literature 2: Japanese Patent Application Laid-open No. 2009-158396

Patent Literature 3: Japanese Patent Application Laid-open No. 2006-059690

### SUMMARY OF INVENTION

During the initial charging of a lithium secondary battery, a portion of the electrolyte components (nonaqueous solvent, supporting salt, and so forth) undergoes reductive degradation with the formation of a coating film (SEI: solid-electrolyte interphase) on the surface of the negative electrode active material. This functions to stabilize the interface between the negative electrode surface and the electrolyte and can prevent additional reductive degradation of the electrolyte during normal use. However, this SEI film grows in high-temperature environments in batteries with the structure under consideration, and this may increase the internal resistance and may also produce irreversible capacity. As a consequence, excellent properties in high-temperature environments (for example, the capacity ratio in a high-temperature environment, i.e., the high-temperature storability) are very important for a lithium secondary battery in service (typically a vehicle drive power supply) where the use environment and/or the storage environment can assume high temperatures (for example, 50° C. to 70° C.). The art described in Patent Literature 1, Patent Literature 2, and Patent Literature 3, however, does not consider this problem.

The present invention was pursued considering this point, and an object of the present invention is to provide a lithium secondary battery that has excellent high-temperature storage characteristics. An additional object of the present invention is preferably to provide a lithium secondary battery that, in addition to having such high-temperature storage characteristics, has improved battery properties (for example, a reduced resistance).

In order to realize these objects, the present invention provides a method for manufacturing a lithium secondary battery, the method including: preparing a slurry negative electrode composite material layer-forming composition containing a negative electrode active material and a binder; preparing a slurry positive electrode composite material layer-forming composition containing a positive electrode active material and a binder; applying the negative electrode composite material layer-forming composition onto a negative electrode current collector to form a negative electrode that is provided with a negative electrode composite material layer on the current collector; applying the positive electrode composite material layer-forming composition onto a positive electrode current collector to form a positive electrode that is provided with a positive electrode composite material layer on the current collector; and fabricating a lithium secondary battery by using the negative electrode and the positive electrode. The negative electrode used to fabricate the lithium secondary battery in the herein disclosed manufacturing method characteristically has a maximum point, in accordance with measurement of pore distribution based on a mercury intrusion technique, in the pore diameter range (A) of from at least 0.3 μm to not more than 4 μm and in the pore diameter range (B) of from at least 0 μm to less than 0.3 μm, and has a ratio (V_{A}/V_{B}) between the pore volume (V_{A}) at the maximum point in the range A and the pore volume (V_{B}) at the maximum point in the range B of from at least 2.1 to not more than 3.4.

With the herein disclosed manufacturing method, growth of the SEI film at the surface of the negative electrode active material particle is inhibited even when the use environment and/or the storage environment assumes a high temperature (for example, 50° C. to 70° C.), and as a consequence the irreversible capacity can be reduced and the contact resistance between negative electrode active material particles can also be reduced. A lithium secondary battery provided with the present negative electrode composite material layer has excellent high-temperature storage characteristics as a result. In addition, excellent electroconductive pathways (electroconductive paths) can be maintained within this composite material layer because favorable pores are secured within the negative electrode composite material layer by the herein disclosed manufacturing method. Moreover, excellent battery properties (for example, a reduction in the battery resistance) can be preferably manifested because the diffusion resistance for the lithium ion can be reduced.

In a preferred aspect of the herein disclosed method for manufacturing a lithium secondary battery, a negative electrode is formed in which the density of the negative electrode composite material layer is from at least 1.0 g/cm³ to not more than 1.6 g/cm³.

A lithium secondary battery provided with a negative electrode composite material layer that satisfies the indicated density range has a high energy density and can exhibit excellent battery properties even in a high-temperature environment. In addition, because favorable pores are secured within this composite material layer, the lithium ion diffusion resistance can be reduced and even better battery properties (for example, a reduction in battery resistance) can be exhibited.

In a preferred aspect of the herein disclosed method for manufacturing a lithium secondary battery, the negative electrode active material is a graphite that has a cumulative 50% particle diameter (D₅₀) measured by a particle size distribution measurement (laser diffraction/light scattering technique) of from at least 3 μm to not more than 20 μm and a specific surface area, measured by a nitrogen adsorption technique, of from at least 2 m²/g to not more than 40 m²/g.

When used as a negative electrode active material, graphite provides a high level of safety and, due to its large theoretical capacity, can provide a high energy density. In addition, a negative electrode composite material layer comprising a graphite that satisfies the indicated particle diameter range can secure suitable pores in the composite material layer and as a result can lower the lithium ion diffusion resistance. Moreover, graphite that satisfies the indicated specific surface area range provides an even higher energy density and can provide an even greater reduction in the contact resistance within the negative electrode active material in high-temperature environments. A battery equipped with such a graphite can therefore exhibit even better properties (for example, a reduction in the battery resistance).

In a preferred aspect of the herein disclosed method for manufacturing a lithium secondary battery, the negative electrode composite material layer-forming composition comprises a styrene-butadiene rubber and/or a carboxymethyl cellulose.

This binder has an excellent bonding behavior and can form excellent electroconductive pathways (electroconductive paths) between negative electrode active material particles and between these active material particles and the negative electrode current collector. As a consequence, the resistance within the negative electrode composite material layer can be lowered and the battery properties can then be improved.

In a preferred aspect of the herein disclosed method for manufacturing a lithium secondary battery, the solids concentration in the negative electrode composite material layer-forming composition is from at least 40% to not more than 60%.

A solids concentration in the negative electrode composite material slurry in the indicated range provides an excellent dispersibility in the slurry and thus yields an excellent coating behavior due to the almost complete absence of coarse aggregates. The negative electrode composite material layer can also be formed with good accuracy, which as a consequence enables the formation of excellent electroconductive pathways (electroconductive paths) within the negative electrode composite material layer. Thus, the internal resistance of a lithium secondary battery equipped with such a negative electrode composite material layer can be lowered and the battery properties can be improved still further.

In order to realize the objects cited above, the present invention also provides a lithium secondary battery that is equipped with an electrode assembly that has a positive electrode and a negative electrode, wherein the negative electrode is provided with a negative electrode current collector and a negative electrode composite material layer formed on the negative electrode current collector, and wherein the negative electrode composite material layer comprises a negative electrode active material and a binder. This negative electrode composite material layer characteristically has a maximum point, in the pore distribution based on a mercury intrusion technique, in the pore diameter range (A) of from at least 0.3 μm to not more than 4 μm and in the pore diameter range (B) of from at least 0 μm to less than 0.3 μm, and a ratio (V_{A}/V_{B}) between the pore volume (V_{A}) at the maximum point in the range A and the pore volume (V_{B}) at the maximum point in the range B of from at least 2.1 to not more than 3.4.

A battery with this structure provides, for the reasons cited above, a reduction in the irreversible capacity even in a high-temperature environment and can thus maintain an excellent capacity ratio. In addition, the lithium ion diffusion resistance can be lowered while retaining excellent electroconductive pathways within the negative electrode composite material layer. As a consequence, excellent battery properties (for example, a lowering of the battery resistance) can be exhibited by a lithium secondary battery that has the indicated negative electrode composite material layer.

In a preferred aspect of the herein disclosed lithium secondary battery, the density of the negative electrode composite material layer is from at least 1.0 g/cm³ to not more than 1.6 g/cm³.

As above, a lithium secondary battery provided with a negative electrode composite material layer that satisfies the indicated density range has a high energy density and can exhibit excellent battery properties even in a high-temperature environment. In addition, the lithium ion diffusion resistance can be reduced and the battery properties of this battery can then be improved.

In a preferred aspect of the herein disclosed lithium secondary battery, the negative electrode active material uses a graphite that has a cumulative 50% particle diameter (D₅₀) measured by a particle size distribution measurement (laser diffraction/light scattering technique) of from at least 3 μm to not more than 20 μm and a specific surface area of from at least 2 m²/g to not more than 40 m²/g.

As above, a negative electrode composite material layer comprising graphite that satisfies the indicated particle diameter range can lower the lithium ion diffusion resistance. In addition, graphite that satisfies the indicated specific surface area range provides a high energy density and can provide an even greater reduction in the contact resistance within the negative electrode active material in high-temperature environments. The battery characteristics of this battery can be improved even further as a consequence.

In a preferred aspect of the herein disclosed lithium secondary battery, the negative electrode composite material layer-forming composition at least comprises a styrene-butadiene rubber and a carboxymethyl cellulose.

This binder has an excellent adhesiveness and can form excellent electroconductive pathways (electroconductive paths) within the negative electrode composite material layer. The battery characteristics of this battery can be improved even further as a consequence.

In a preferred aspect of the herein disclosed lithium secondary battery, the product of its IV resistance (mΩ) at 25° C. and its battery capacity (Ah) is not more than 18 (mΩ·Ah) and the product of its direct-current resistance (mΩ) at 25° C. based on an alternating-current impedance measurement and its battery capacity (Ah) is not more than 20 (mΩ·Ah).

The battery properties of such a battery can be improved because its resistance is lower than heretofore.

The herein disclosed lithium secondary battery in particular has excellent high-temperature storage characteristics and can exhibit improved battery characteristics (for example, a reduction in internal resistance), and as a consequence is well suited, for example, as a drive power supply mounted in a vehicle, e.g., an automobile. Accordingly, the present invention provides a vehicle (typically driven by an electric motor, such as a plug-in hybrid vehicle (PHV), hybrid vehicle (HV), or electric vehicle (EV)) that is equipped with any of the herein disclosed lithium secondary batteries (this can be in the form of a battery pack in which a plurality of the lithium secondary batteries are connected).

### BRIEF DESCRIPTION OF DRAWINGS

FIG. 1 is a schematic diagram that shows the structure of a lithium secondary battery according to an embodiment of the present invention;

FIG. 2 is a schematic diagram that shows the structure of a wound electrode assembly in a lithium secondary battery according to an embodiment of the present invention;

FIG. 3 is a side view diagram that schematically shows a vehicle (an automobile) in which a lithium secondary battery according to an embodiment of the present invention is provided as a vehicle drive power supply;

FIG. 4 is a chart that shows, in accordance with an example of the present invention, the pore distribution of the negative electrode composite material layer as measured by a mercury intrusion technique;

FIG. 5 is a graph that shows the relationship between V_{A}/V_{B} and the capacity ratio (%) according to an example of the present invention;

FIG. 6 is a graph that shows the relationship between V_{A}/V_{B} and the IV resistance value; and

FIG. 7 is a graph that shows the relationship between V_{A}/V_{B} and the direct-current resistance value.

### DESCRIPTION OF EMBODIMENTS

In this Description, a “lithium secondary battery” refers to a secondary battery that uses the lithium ion as an electrolyte ion and that realizes charge and discharge by the movement of the charge associated with the lithium ion between the positive and negative electrodes. The secondary batteries generally known as lithium ion batteries (or lithium ion secondary batteries), lithium polymer batteries, lithium-air batteries, lithium-sulfur batteries, and so forth, are typical examples encompassed by the lithium secondary battery in this Description. In this Description, the “active material” refers to a substance (compound) that participates in the storage of power on the positive electrode side or the negative electrode side. That is, “active material” refers to a substance that participates in the insertion and extraction of electrons during battery charge and discharge.

Preferred embodiments of the herein disclosed lithium secondary battery are described in the following. Matters required for execution but not particularly described in this Description can be understood as design matters for the individual skilled in the art based on the conventional art in the pertinent field. The lithium secondary battery with the present structure can be realized based on the contents disclosed in this Description and the common general technical knowledge in the pertinent field.

As has been described above, the herein disclosed manufacturing method is a method that has characteristic features with regard to the fabrication of the negative electrode composite material layer, and comprises preparing a slurry negative electrode composite material layer-forming composition comprising a negative electrode active material and a binder; applying the negative electrode composite material layer-forming composition onto a negative electrode current collector to form a negative electrode that is provided with a negative electrode composite material layer on the current collector; preparing a slurry positive electrode composite material layer-forming composition comprising a positive electrode active material and a binder; applying the positive electrode composite material layer-forming composition onto a positive electrode current collector to form a positive electrode that is provided with a positive electrode composite material layer on the current collector; and fabricating a lithium secondary battery using the negative electrode and the positive electrode. Hereinbelow, a preferred mode of the manufacturing method is explained in detail.

The negative electrode used in the lithium secondary battery in the herein disclosed manufacturing method has a form provided by mixing a negative electrode active material, a binder (bonding agent), and so forth, in a suitable solvent to prepare a slurry (this also encompasses pastes and inks) negative electrode composite material layer-forming composition (referred to below as the “negative electrode composite material slurry”) and forming a negative electrode composite material layer (also referred to as the negative electrode active material layer) by the application of this slurry to a negative electrode current collector.

One or two or more of the materials heretofore used in lithium secondary batteries can be used without particular limitation for the negative electrode active material used here. Examples are particulate graphite powder (carbon particles) that at least partially comprise a graphite structure (layer structure); oxides such as lithium titanate (LTO) and so forth; and alloys of lithium with tin (Sn) or silicon (Si). The graphite powder can be, for example, a graphite powder, a graphitization-resistant carbonaceous powder (hard carbon), an easily-graphitizable carbonaceous powder (soft carbon), or a combination of the preceding, with the use of graphite being preferred among the preceding. This graphite can be, for example, one or two or more selections from, e.g., natural graphite (also known as plumbago or black lead) recovered from the naturally occurring mineral, artificial graphites produced from petroleum- or coal-based materials, and graphites provided by subjecting the preceding graphites to processing such as, e.g., pulverization, pressing, and so forth. More specific examples are flake graphite, crystalline (vein) graphite, amorphous graphite, expanded graphite, and pyrolytic graphite. The shape can be, for example, flake, spherical, fibrous, or granular. The proportion of the negative electrode active material in the negative electrode composite material layer as a whole is not particularly limited, but generally at least about 50% by mass is favorable while about 90% by mass to 99% by mass (for example, about 95% by mass to 99% by mass) is preferred.

A suitable range for the herein used negative electrode active material for the cumulative 50% particle diameter (D₅₀) in the particle size distribution measured by a particle size distribution measurement (laser diffraction•light scattering technique) is from at least 2 μm (preferably at least 3 μm) to not more than 50 μm (typically not more than 30 μm and preferably not more than 20 μm). A negative electrode active material that satisfies this particle diameter range forms favorable pores in the negative electrode composite material layer and can lower the diffusion resistance associated with lithium ion insertion and extraction. In addition, excellent electroconductive pathways (electroconductive paths) can be formed within the negative electrode composite material layer and as a consequence the battery properties can be improved (for example, the resistance can be reduced and the high-temperature storage characteristics can be improved).

The particle size distribution can be measured by a particle size distribution measurement based on a laser diffraction•light scattering technique. Specifically, the sample (powder) is first dispersed in the measurement solvent. At this point a dispersing agent, e.g., a surfactant, is added within a range that does not influence the measurement results. The resulting dispersion is then introduced into, for example, a model “LA-920” particle size distribution analyzer from HORIBA, Ltd., and the value thereby measured can be used. In this Description, “particle diameter” denotes the value derived from the volume-based particle size distribution calculated from these measurement results, while the cumulative 50% particle diameter (D₅₀) indicates the particle diameter (median diameter) that corresponds to the cumulative 50% from the microfine particle side in the volume-based particle size distribution.

The specific surface area of the negative electrode active material used here is preferably at least 1 m²/g (for example, preferably at least 2 m²/g and more preferably at least 4 m²/g). In addition, it is preferably in the range of equal to or less than 50 m²/g (for example, not more than 40 m²/g or not more than 30 m²/g). When the specific surface area is too small, a satisfactory energy density may not be obtained and/or the contact resistance between the active material particles may increase. When, on the other hand, the specific surface area is too large, the irreversible capacity in a high-temperature environment may increase, as in an example described below, and the battery capacity may then decline.

With regard to measurement of the specific surface area, the value (BET specific surface area) can be used as measured by a gas adsorption technique that measures the nitrogen gas adsorption isotherm, for example, by a constant-volume adsorption technique using a “BELSORP (trademark)-18PLUS” automatic specific surface area/particle size distribution analyzer from BEL Japan, Inc. Specifically, about 0.4 g of the sample (powder) is filled into the cell and is pretreated by heating in a vacuum and is then cooled to the temperature of liquid nitrogen and a saturation adsorption with a 30% nitrogen/70% He gas is carried out. After this, the amount of gas desorbing during heating to room temperature is measured and the specific surface area by the BET method (for example, the single-point BET procedure) is calculated from the obtained results.

One or two or more of the materials heretofore used in lithium secondary batteries can be used without particular limitation for the binder used here. Various polymer materials can typically be favorably used. For example, when the negative electrode composite material layer is formed using a water-based composition in liquid form, a polymer material that dissolves or disperses in water is preferably used. Such a polymer material can be exemplified by cellulosic polymers, fluororesins, vinyl acetate copolymers, and rubbers. They can be more specifically exemplified by carboxymethyl cellulose (CMC), hydroxypropyl methyl cellulose (HPMC), polyvinyl alcohol (PVA), polytetrafluoroethylene (PTFE), tetrafluoroethylene-hexafluoropropylene copolymer (FEP), styrene-butadiene rubber (SBR), and acrylic acid-modified SBR resin (SBR latex). Among the preceding, SBR and CMC are favorably used because they have an excellent binding behavior and can form excellent electroconductive paths between negative electrode active material particles and between these active material particles and the negative electrode current collector.

Or, when the negative electrode composite material layer is formed using a solvent-based composition in liquid form (a solvent-based composition in which the main component of the dispersing medium is an organic solvent), a polymer material that disperses or dissolves in organic solvent is preferably used. Such a polymer material can be exemplified by polyvinylidene fluoride (PVdF), polyvinylidene chloride (PVdC), and polyethylene oxide (PEO). While not intended as a particular limitation, the amount of binder used in the negative electrode composite material layer as a whole can be, for example, 0.1% by mass to 10% by mass (preferably 0.5% by mass to 5% by mass).

One or two or more of the solvents heretofore used with lithium secondary batteries can be used without particular limitation as the solvent used here. Such solvents can be roughly classified into water-based solvents and organic solvents. The water-based solvent is preferably water or a mixed solvent that is mainly water. One or two or more suitable selections from organic solvents that can uniformly mixed with water (e.g., lower alcohols, lower ketones) can be used as the solvent other than water that makes up such a mixed solvent. For example, the use is preferred of a water-based solvent in which at least about 80% by mass (more preferably at least about 90% by mass and even more preferably at least about 95% by mass) of the water-based solvent is water. A particularly preferred example is a water-based solvent substantially comprised of water (for example, water). The organic solvent can be exemplified by amides, alcohols, ketones, esters, amines, ethers, nitriles, cyclic ethers, and aromatic hydrocarbons. It can be more specifically exemplified by N-methyl-2-pyrrolidone (NMP), N,N-dimethylformamide (DMF), N,N-dimethylacetamide, 2-propanol, ethanol, methanol, acetone, methyl ethyl ketone, cyclohexanone, methyl acetate, ethyl acetate, methyl acrylate, diethylenetriamine, N,N-dimethylaminopropylamine, acetonitrile, ethylene oxide, tetrahydrofuran (THF), dioxane, benzene, toluene, ethylbenzene, xylene, dimethyl sulfoxide (DMSO), dichloromethane, trichloromethane, and dichloroethane.

As necessary, a material capable of functioning as a dispersing agent, an electroconductive material, and so forth, may be added to the negative electrode composite material slurry that is prepared here. This dispersing agent can be exemplified by polymer compounds (for example, an alkali salt and typically a sodium salt) that have a hydrophobic chain and a hydrophilic group, by anionic compounds that have, for example, a sulfate salt, sulfonate salt, or phosphate salt; and by cationic compounds such as amines. It can be more specifically exemplified by carboxymethyl cellulose (CMC), methyl cellulose, ethyl cellulose, hydroxypropyl cellulose, polyvinyl alcohol, modified polyvinyl alcohol, polyethylene oxide, polyvinylpyrrolidone, polycarboxylic acids, oxidized starch, and starch phosphate, and, for example, water-soluble polymer materials such as carboxymethyl cellulose are preferably used.

With regard to the method for preparing the negative electrode composite material slurry, the negative electrode active material, binder, and additives such as a dispersing agent may be introduced all at one into the solvent and mixed, or may be divided into some number of portions and introduced in stages with mixing. For example, a procedure can be used in which CMC, which can function as a binder and as a dispersing agent, is first dispersed in an amount of solvent smaller than the final amount of solvent, and the negative electrode active material and SBR in its role as a binder are subsequently introduced in stages. A negative electrode composite material slurry in which the negative electrode active material is uniformly dispersed can thus be obtained by dispersing the CMC, which has a relatively poor dispersibility at high molecular weights, in the solvent first. While not intended as a particular limitation, the solids concentration in the negative electrode composite material slurry (referred to below as the “NV”) is at least about 30% (preferably at least 40% and more preferably at least 45%) and is not more than 70% (preferably not more than 60% and more preferably not more than 55%). The dispersibility and coating behavior are excellent when the solids concentration in the slurry is in the indicated range. The negative electrode composite material layer can be formed with good accuracy as a consequence.

In a preferred method for forming the negative electrode composite material layer, a suitable amount of the negative electrode composite material slurry is applied on one side or both sides of the negative electrode current collector and drying is carried out.

The application of this negative electrode composite material slurry can be carried out by the same procedures as heretofore used in the fabrication of the negative electrode for ordinary lithium secondary batteries. For example, production can be carried out by coating a prescribed amount of the negative electrode composite material slurry in a uniform thickness on the negative electrode current collector using a suitable coating apparatus (e.g., a slit coater, die coater, comma coater, gravure coater, and so forth).

The solvent present in the negative electrode composite material slurry is subsequently removed by drying the negative electrode composite material layer using a suitable drying means. The drying of the negative electrode composite material layer can use, for example, natural drying, a hot gas current, a low-humidity gas current, a vacuum, infrared radiation, far infrared radiation, an electron beam, and so forth, either singly or in combination. In a preferred embodiment the drying temperature is made not more than about 200° C. (typically from at least 80° C. to less than 200° C.). The negative electrode for the herein disclosed lithium secondary battery can be obtained by proceeding as described above.

The material of the negative electrode current collector here can be exemplified by copper, nickel, titanium, and stainless steel. Its shape is not particularly limited, and a rod shape, plate shape, foil, mesh, and so forth, may be used. A foil is used in a battery that incorporates a wound electrode assembly, infra. The thickness of the foil current collector is not particularly limited, but, viewed in terms of obtaining a good balance between the capacity density of the battery and the strength of the current collector, preferably about 5 μm to 200 μm (more preferably 8 μm to 50 μm) is used.

After the negative electrode composite material slurry has been dried, the thickness, density, and pore distribution of the negative electrode composite material layer can be adjusted by carrying out a suitable pressing treatment (for example, various heretofore known pressing methods can be used, e.g., a roll pressing method, a platen pressing method, and so forth). The density of the negative electrode composite material layer formed on the negative electrode current collector can be, for example, at least 1.0 g/cm³ (preferably at least 1.1 g/cm³ and more preferably at least 1.2 g/cm³) and not more than 1.6 g/cm³ (preferably not more than 1.5 g/cm³). The capacity per unit volume of the battery is reduced when the negative electrode composite material layer has a low density (i.e., there is a small amount of active material in the negative electrode composite material layer). When this density is too high, as shown in an example, infra, the diffusion resistance accompanying lithium ion insertion•extraction undergoes an increase and the internal resistance then tends to increase. However, a lithium secondary battery that has a negative electrode composite material layer that satisfies the indicated density range has a high energy density and can provide a reduced lithium ion diffusion resistance and as a consequence can realize even better battery characteristics (for example, a reduction in the battery resistance).

The negative electrode used in the herein disclosed lithium secondary battery has a maximum point, in the pore distribution based on a mercury intrusion technique, in the pore diameter range of from at least 0.3 μm to not more than 4 μm (A) and in the pore diameter range of from at least 0 μm to less than 0.3 μm (B), and has a ratio (V_{A}/V_{B}) between the pore volume (V_{A}) at the maximum point in the range A and the pore volume (V_{B}) at the maximum point in the range B of from at least 2.1 to not more than 3.4. In general, the storage of a lithium secondary battery in a high SOC region (for example, an SOC of 80% to 100%) and/or in a high-temperature range (for example, 50° C. to 70° C.) causes a substantial decline in the capacity of this battery. This is due to the generation of irreversible capacity in association with the growth of the SEI film at the surface of the negative electrode active material particles. However, with a negative electrode that satisfies the indicated ranges, SEI film growth at the surface of the active material particles can be inhibited even when the use environment and/or storage environment assumes a high temperature, and as a consequence the irreversible capacity and the contact resistance between negative electrode active material particles can be reduced. Here, “SOC” denotes the state of charge, and, for the operating voltage range in which reversible charge/discharge is possible, indicates the state of charge where 100% is assigned to the state of charge when the upper limit voltage is obtained (i.e., a fully charged state) and 0% is assigned to the state of charge when the lower limit voltage is obtained (an uncharged state).

Favorable pores are secured in the negative electrode composite material layer with a negative electrode that satisfies the above-indicated ranges, and as a consequence the lithium ion diffusion resistance can be reduced while maintaining excellent electroconductive pathways (electroconductive paths) within this composite material layer. Thus, a lithium secondary battery provided with this negative electrode composite material layer has excellent high-temperature storage characteristics and can bring about improved battery characteristics (for example, a reduced resistance) and in particular is favorable as a battery for service where use and/or storage in a high-temperature environment can occur.

The mercury intrusion-based pore distribution in the negative electrode composite material layer can be measured using a mercury porosimeter. Mercury intrusion is a method that can measure the pore distribution in a porous article and can access the gaps between particles in the negative electrode composite material layer (i.e., the pores among the negative electrode active material) as well as the micropores present at the surface of this active material. These pores can be adjusted through the type and properties (for example, the specific surface area) of the negative electrode active material that is used and through conditions such as the NV value and the rolling pressure (pressing) during application of the negative electrode composite material slurry.

With regard to the specific measurement method for mercury intrusion, a sample is first obtained by stripping the negative electrode composite material layer to be measured from the negative electrode current collector. This sample is then immersed in mercury under a vacuum and the pressure is gradually raised. When this is done, the mercury intrudes into the pores in the sample and the pore volume can then be measured. That is, as the pressure exerted on the mercury rises, the mercury gradually permeates into smaller spaces. Since this pressure and the pore size are inversely proportional, the pore sizes in the sample and their volume distribution can be determined based on this relationship. For example, an Autopore III 9410 from the Shimadzu Corporation can be used for the instrumentation here. In this case, for example, measurement at from 4 psi to 60,000 psi can acquire the volume distribution of pores that correspond to the pore range of 50 μm to 0.003 μm.

The positive electrode of the herein disclosed lithium secondary battery has a configuration provided by preparing a slurry (this also encompasses pastes and inks) positive electrode composite material layer forming-composition (referred to in the following as the “positive electrode composite material slurry”) by mixing a positive electrode active material, electroconductive material, binder, and so forth. This slurry is applied to a positive electrode current collector to form a positive electrode composite material layer (also referred to as a positive electrode active material layer).

One or two or more of the materials heretofore used in lithium secondary batteries can be used without particular limitation as the herein used positive electrode active material. Examples are oxides containing lithium and a transition metal element as structural metal elements (lithium transition metal oxides), e.g., lithium nickel oxide (for example, LiNiO₂), lithium cobalt oxide (for example, LiCoO₂), and lithium manganese oxide (for example, LiMn₂O₄), and phosphate salts that contain lithium and a transition metal element as structural metal elements, e.g., lithium manganese phosphate (LiMnPO₄) and lithium iron phosphate (LiFePO₄). Among the preceding, positive electrode active materials in which the main component is a layer-structured lithium nickel cobalt manganese complex oxide (for example, LiNii_{1/3}Co_{1/3}Mn_{1/3}O₂)—typically a positive electrode active material substantially comprising a lithium nickel cobalt manganese complex oxide—exhibit an excellent thermal stability and also a high energy density and are thus preferred for use. In addition, while not intended as a particular limitation, the proportion of the positive electrode active material in the positive electrode composite material layer as a whole is typically at least about 50% by mass (typically 70% by mass to 99% by mass) and is preferably about 80% by mass to 99% by mass.

The lithium nickel cobalt manganese complex oxide under consideration encompasses not only oxides in which Li, Ni, Co, and Mn are the structural metal elements, but also encompasses oxides that contain at least one metal element other than Li, Ni, Co, and Mn (a transition metal element and/or a main group metal element in addition to Li, Ni, Co, and Mn). This metal element can be, for example, one or two or more elements from among Al, Cr, Fe, V, Mg, Ti, Zr, Nb, Mo, W, Cu, Zn, Ga, In, Sn, La, and Ce. The same also applies to lithium nickel oxide, lithium cobalt oxide, and lithium manganese oxide. For example, the lithium transition metal oxide powders prepared by heretofore known methods can be used as such as the lithium transition metal oxide (typically in particulate form) under consideration here.

The electroconductive material used herein can be one or two or more of the materials heretofore used in lithium secondary batteries without particular limitation. For example, it can be one or two or more selections from the various carbon blacks (for example, acetylene black (AB), furnace black, Ketjen black (KB), channel black, lamp black, and thermal black), graphite powders (the natural or synthetic material), and carbon fibers (PAN-based fibers, pitch-based fibers). Or, a metal fiber (for example, of Al or SUS), electroconductive metal powder (for example, of Ag, Ni, or Cu), metal oxide (for example, ZnO and SnO₂), or synthetic fiber with a metal-coated surface may be used. Acetylene black (AB) is a preferred carbon powder among the preceding. The proportion of the electroconductive agent in the positive electrode composite material layer as a whole can be, for example, about 1% by mass to 15% by mass and is preferably about 2% by mass to 8% by mass (more preferably 2% by mass to 6% by mass).

For the binder used here, a suitable selection can be made from the polymer materials provided above as examples of the binder for the negative electrode composite material layer. Examples are polyvinylidene fluoride (PVdF), polytetrafluoroethylene (PTFE), and styrene-butadiene rubber (SBR). The proportion of the binder in the positive electrode composite material layer as a whole can be, for example, about 0.1% by mass to 10% by mass and is preferably about 1% by mass to 5% by mass.

With regard to the method for forming the positive electrode composite material layer, a method is preferably used in which, using the same procedures as described above for the negative electrode composite material layer, the positive electrode composite material slurry is coated in a suitable amount on one side or both sides of the positive electrode current collector and drying is carried out.

This is followed, as for the negative electrode composite material layer as described about, by drying the positive electrode composite material layer by a suitable drying means to remove the solvent present in the positive electrode composite material slurry. After the positive electrode composite material slurry has been dried, the thickness and density of the positive electrode composite material layer may be adjusted by the execution of a suitable pressing treatment (for example, roll pressing, platen pressing).

The material of this positive electrode current collector can be exemplified by aluminum, nickel, titanium, and stainless steel. The shape of the current collector is not particularly limited since it can vary in conformity with, for example, the shape of the battery fabricated using the resulting electrode; however, for example, a rod shape, plate shape, foil, mesh, and so forth, may be used. Mainly a foil is used in a battery that incorporates a wound electrode assembly, infra. The thickness of the foil current collector is not particularly limited, but, viewed in terms of obtaining a good balance between the capacity density of the battery and the strength of the current collector, preferably about 5 μm to 200 μm (more preferably 8 μm to 50 μm) is used.

The lithium secondary battery is fabricated by producing an electrode assembly in which the positive electrode and negative electrode are layered and housing this together with an electrolyte solution in a suitable battery case. A separator is interposed between the positive electrode and negative electrode in a typical structure for the herein disclosed lithium secondary battery.

The materials and shapes used in conventional lithium secondary batteries can be used for the battery case. The material can be exemplified by relatively light-weight metals such as aluminum and steel and by resins such as PPS and polyimide resin. The shape (outer shape of the container) is not particularly limited and can be exemplified by a cylindrical shape, square shape, rectangular parallelepiped shape, coin shape, and bag shape. In addition, a safety mechanism, for example, a current interrupt mechanism (a mechanism that can interrupt the current in response to an increase in internal pressure when the battery is overcharged) may be disposed in the case.

One or two or more of the same nonaqueous electrolyte solutions as used in conventional lithium secondary batteries may be used without particular limitation for the electrolyte solution used in the present instance. This nonaqueous electrolyte solution typically has a composition in which an electrolyte (lithium salt) is incorporated in a suitable nonaqueous solvent.

Aprotic solvents such as carbonates, esters, ethers, nitriles, sulfones, and lactones may be used for the nonaqueous solvent. Examples here are ethylene carbonate (EC), propylene carbonate (PC), diethyl carbonate (DEC), dimethyl carbonate (DMC), ethyl methyl carbonate (EMC), 1,2-dimethoxyethane, 1,2-diethoxyethane, tetrahydrofuran, 2-methyltetrahydrofuran, dioxane, 1,3-dioxolane, diethylene glycol dimethyl ether, ethylene glycol dimethyl ether, acetonitrile, propionitrile, nitromethane, N,N-dimethylformamide, dimethyl sulfoxide, sulfolane, and γ-butyrolactone. The use is preferred among the preceding of nonaqueous solvents comprising mainly carbonate. For example, the use is preferred of a nonaqueous electrolyte solution that contains one or two or more carbonates for the nonaqueous solvent wherein the total volume of the carbonates takes up at least 60% by volume (more preferably at least 75% by volume, even more preferably at least 90% by volume, and substantially 100% by volume) of the volume of the overall nonaqueous solvent. In addition, this may be a solid (gel) electrolyte as provided by the addition of a polymer to the liquid electrolyte solution under consideration.

The electrolyte can be exemplified by LiPF₆, LiBF₄, LiClO₄, LiN(SO₂CF₃)₂, LiN(SO₂C₂F₅)₂, LiCF₃SO₃, LiC₄F₉SO₃, LiC(SO₂CF₃)₃, and LiClO₄. The use of LiPF₆ among the preceding is preferred. The concentration of the electrolyte is not particularly limited, but when the electrolyte concentration is too low, insufficient lithium ion is then present in the electrolyte solution and the ionic conductivity will exhibit a declining trend. In addition, when the concentration of the supporting electrolyte is too high, the nonaqueous electrolyte solution will have an overly high viscosity and the ionic conductivity will exhibit a declining trend. As a consequence, the use is preferred of a nonaqueous electrolyte solution that contains the electrolyte at a concentration of about 0.1 mol/L to 5 mol/L (preferably about 0.8 mol/L to 1.5 mol/L).

Various additives may be added as appropriate to the electrolyte solution used in the present instance, for example, additives that improve the battery properties (specifically vinylene carbonate (VC), fluoroethylene carbonate (FEC), and so forth) and overcharge inhibitors (refers to compounds that undergo degradation, with the generation of large amounts of gas, when an overcharge condition is reached; specific examples are biphenyl (BP) and cyclohexylbenzene (CHB)).

The same porous sheets as heretofore used in lithium secondary batteries can be used as the separator used here. Examples are porous resin sheets (e.g., films, nonwoven fabrics, and so forth) comprising a resin such as polyethylene (PE), polypropylene (PP), polyester, cellulose, or polyamide. This porous resin sheet may have a monolayer structure or a multilayer structure of two more layers (for example, a three-layer structure in which a PP layer is laminated on both sides of a PE layer). While not intended as a particular limitation, an example for the properties of a porous sheet (typically a porous resin sheet) preferred for use as the separator substrate is a porous resin sheet having an average pore diameter of about 0.001 μm to 30 μm and a thickness of about 5 μm to 100 μm (more preferably 10 μm to 30 μm). The porosity (void ratio) of this porous sheet can be, for example, about 20% by volume to 90% by volume (preferably 30% by volume to 80% by volume). A lithium secondary battery that uses a solid electrolyte (a lithium polymer battery) may have a structure in which the electrolyte also functions as the separator.

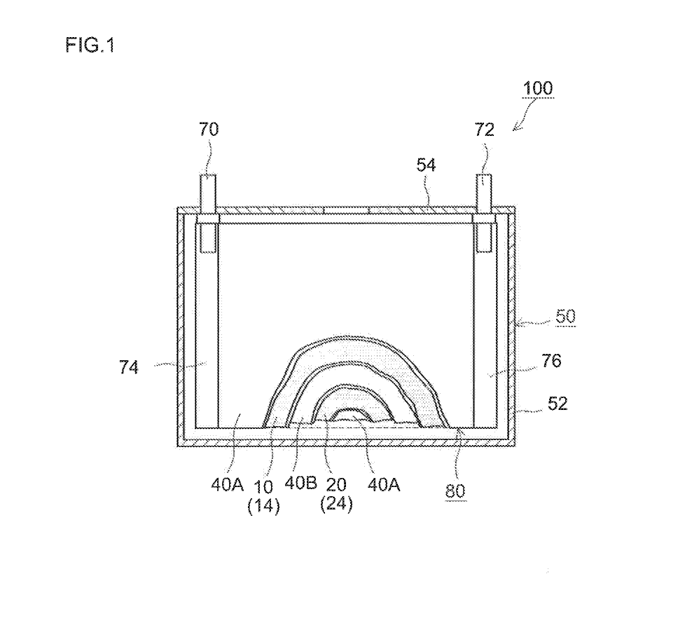

While not intended as a particular limitation, a lithium secondary battery (cell) with a configuration in which a flat wound electrode assembly (wound electrode assembly) and a nonaqueous electrolyte solution are housed in a flat box-shaped (rectangular parallelepiped shape) container, is provided as an example of a schematic structure of a lithium secondary battery according to an embodiment of the present invention, and the schematic structure of this lithium secondary battery is shown in FIGS. 1 to 3. In the following figures, the same reference signs are assigned to members•positions that exercise the same function, and redundant descriptions are either omitted or simplified. The dimensional relationships (length, width, thickness, and so forth) in the figures are not reflective of actual dimensional relationships.

As shown schematically in FIG. 1, a lithium secondary battery 100 according to this embodiment is provided with a wound electrode assembly 80 and a battery case 50 and has a structure in which the electrode assembly (a wound electrode assembly) 80—which has a configuration in which a long positive electrode sheet 10 and a long negative electrode sheet 20 are wound flat with long separators 40A and 40B interposed therebetween—is housed along with a nonaqueous electrolyte solution (not shown) in a flat box-shaped (rectangular parallelepiped shape) battery case 50.

The battery case 50 is provided with a flat, rectangular parallelepiped-shaped case main body 52 having an open upper end and with a lid 54 that covers this opening. In the upper side (i.e., the lid 54) of the battery case 50 there are disposed a positive electrode terminal 70, which is electrically connected to the positive electrode 10 of the wound electrode assembly 80, and a negative electrode terminal 72, which is electrically connected to the negative electrode 20 of this electrode assembly 80.

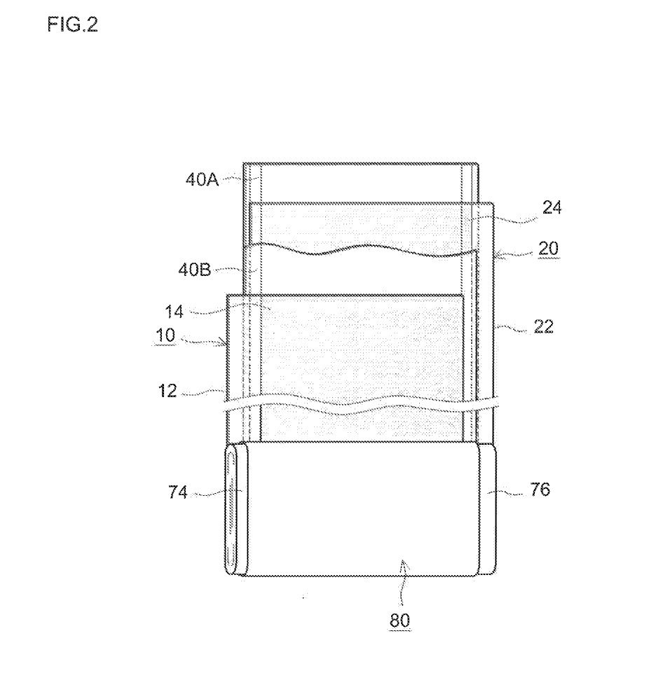

FIG. 2 schematically illustrates a long sheet structure (electrode sheet) in a stage prior to the assembly of the wound electrode assembly 80. The positive electrode sheet 10 has a positive electrode composite material layer 14 formed along the long direction on one side or both sides (typically both sides) of a long positive electrode current collector 12; the negative electrode sheet 20 has a negative electrode composite material layer 24 formed along the long direction on one side or both sides (typically both sides) of a long negative electrode current collector 22; and the wound electrode assembly is fabricated by winding the positive electrode sheet 10 and the negative electrode sheet 20 in the long direction stacked with two long separators 40A and 40B. This wound electrode assembly is then pressed and flattened from the side direction to produce a flat wound electrode assembly 80.

The positive electrode sheet 10 is formed with the positive electrode composite material layer 14 not disposed at (or removed from) one of its edges along the long direction, thereby exposing the positive electrode current collector 12. Similarly, the wound negative electrode sheet 20 is formed with the negative electrode composite material layer 24 not disposed at (or removed from) one of its edges along the long direction, thereby exposing the negative electrode current collector 22. A positive electrode current collection tab is attached to this exposed edge 74 of the positive electrode current collector 12; a negative electrode current collection tab is attached to this exposed edge 76 of the negative electrode current collector 22; and these are electrically connected, respectively, to the positive electrode terminal 70 and the negative electrode terminal 72.

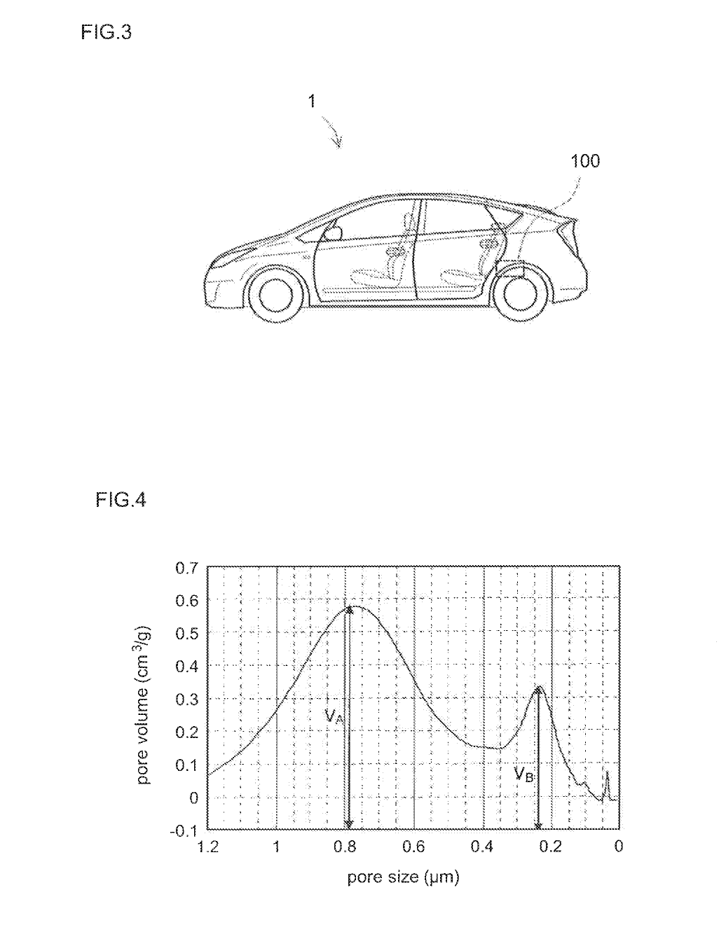

The lithium secondary battery produced by the herein disclosed manufacturing method can be used in a variety of applications, and is characterized by its excellent high-temperature storage characteristics and by the reduction in the resistance of this battery. As a consequence, the herein disclosed lithium secondary battery 100 can be favorably used, for example, as a power supply (drive power supply) for a motor mounted in a vehicle 1, e.g., an automobile, as shown in FIG. 3. While the type of the vehicle 1 is not particularly limited, it can be typically exemplified by plug-in hybrid vehicles (PHVs), hybrid vehicles (HVs), and electric vehicles (EVs). A single lithium secondary battery 100 may be used, or it may be used in the form of a battery pack in which a plurality are connected in series and/or in parallel.

The present invention is specifically described by examples in the following, but this should not be taken to imply that the present invention is limited to what is shown in these examples.

### Example 1

A water-based negative electrode composite material slurry was first prepared by mixing an artificial graphite (powder) as the negative electrode active material, a styrene-butadiene rubber (SBR), and a carboxymethyl cellulose (CMC) in a mass ratio among these materials of 98:1:1 with deionized water to provide an NV value of 50% by mass. A sheet-shaped negative electrode (negative electrode sheet (Example 1)) was obtained by coating this slurry on both sides of a long, approximately 10 μm-thick copper foil (negative electrode current collector) to form a negative electrode composite material layer. The thusly obtained negative electrode was dried and was then rolled (pressed) to provide a density for the negative electrode composite material layer of approximately 1.4 g/cm³.

A positive electrode composite material slurry was then prepared by mixing LiNi_{1/3}Co_{1/3}Mn_{1/3}O₂ powder as a positive electrode active material powder, an acetylene black as an electroconductive material, and a polyvinylidene fluoride (PVdF) as a binder in a mass ratio among these materials of 91:6:3 with N-methylpyrrolidone (NMP) to provide an NV value of 55% by mass. A sheet-shaped positive electrode (positive electrode sheet) was obtained by coating this slurry on both sides of a long, approximately 15 μm-thick aluminum foil (positive electrode current collector) to form a positive electrode composite material layer. The thusly obtained positive electrode was dried and was then rolled (pressed) to provide a density for the positive electrode composite material layer of approximately 2.5 g/cm³.

An electrode assembly was produced by stacking the thusly fabricated positive electrode sheet and negative electrode sheet (Example 1) with two separators (a porous polyethylene sheet (PE) was used here) interposed therebetween and winding. This electrode assembly was housed in a cylindrical battery case together with an nonaqueous electrolyte solution (an electrolyte solution was used here in which LiPF₆ as electrolyte was dissolved at a concentration of about 1 mol/L in a mixed solvent containing ethylene carbonate (EC), dimethyl carbonate (DMC), and ethyl methyl carbonate (EMC) in a volumetric ratio of 3:4:3). A lid was placed on the opening in the battery case and was joined by welding to fabricate an 18650-type (diameter=18 mm, height=65 mm, battery capacity=0.5 Ah) lithium secondary battery (Example 1).

### Examples 2 to 10

In order to assess the favorable V_{A}/V_{B} range in the herein disclosed manufacturing method, negative electrode sheets (Examples 2 to 10) were fabricated as in Example 1 while adjusting the particle diameter of the negative electrode active material used and the rolling (pressing) conditions for the negative electrode composite material layer. Using these negative electrode sheets (Examples 2 to 10), 18650-type (diameter=18 mm, height=65 mm) lithium secondary batteries (Examples 2 to 10) were fabricated as in Example 1.

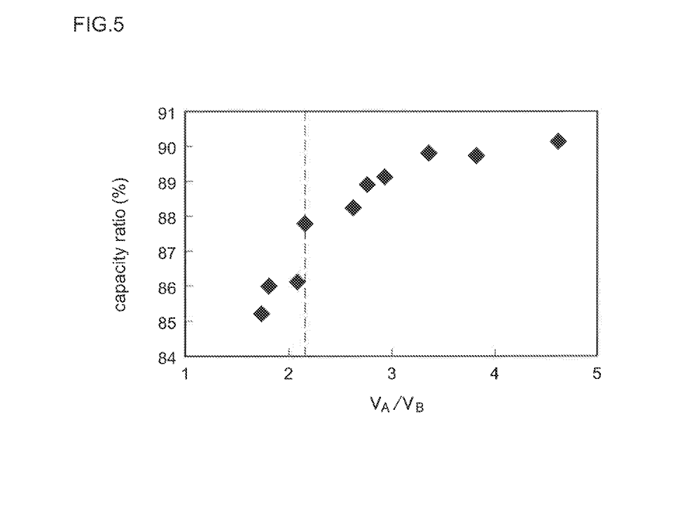

The pore distribution in the negative electrode composite material layer formed in the thusly fabricated negative electrode sheets (Examples 1 to 10) was measured by the method already described above. The pore distribution (chart) in Example 1 is given in FIG. 4 as a typical measurement example.

As shown in FIG. 4, two major peaks were seen in the pore distribution in the negative electrode composite material layer of Example 1, and these had a maximum at about 0.8 μm and at about 0.25 μm. In addition, the ratio (V_{A}/V_{B}) between the pore volume for the peak with the maximum at 0.8 μm (V_{A}; 0.58 cm³/g) and the pore volume for the peak with the maximum at 0.25 μm (V_{B}; 0.34 cm³/g) was approximately 1.7. It is thought that V_{A} (the larger pores) gives the pore volume between the negative electrode active material particles while Vs (the smaller pores) gives the pore volume for the negative electrode active material particle surface. The same measurement carried out in Examples 2 to 10 gave a V_{A}/V_{B} ratio for the negative electrode composite material layers of 1.8 (Example 2) to 4.6 (Example 10).

The following property evaluation was performed on the thusly fabricated lithium secondary batteries (Examples 1 to 10) after a suitable conditioning treatment (the following initial charge/discharge treatment was carried out four times: a constant-current charging step (CC charging) to 4.2 V at a 0.3 C charging rate and a constant-current discharge step (CC discharge) to 3.0 V at a 0.3 C discharge rate) had been carried out at a temperature of 25° C.

[High-Temperature Storage Test]

After the conditioning treatment as described above and while operating at a temperature of 25° C., each battery was constant-current charged at 1 C to 4.1 V and was then constant-voltage charged until the total charging time reached 2 hours. After this CC-CV charging, the battery was held for 24 hours at a temperature of 25° C. and was subsequently constant-current discharged at 1 C from 4.1 V to 3.0 V and then constant-voltage discharged until the total discharge time reached 2 hours, with the discharge capacity (initial capacity (Cᵢ)) being measured during this procedure. After this measurement of the initial capacity, the battery was submitted to a high-temperature storage test. Specifically, the battery was first adjusted to an SOC of 80% by charging. This was followed by storage for 60 days at 60° C. and then a charge/discharge procedure under the same conditions as described above for the initial capacity measurement, with measurement of the discharge capacity (C_{f}). The capacity ratio after high-temperature storage ((C_{f}/Cᵢ)×100(%)) was calculated from the initial capacity (Cᵢ) and the discharge capacity (C_{f}) after the high-temperature storage test. The results are given in FIG. 5.

[IV Resistance Measurement]

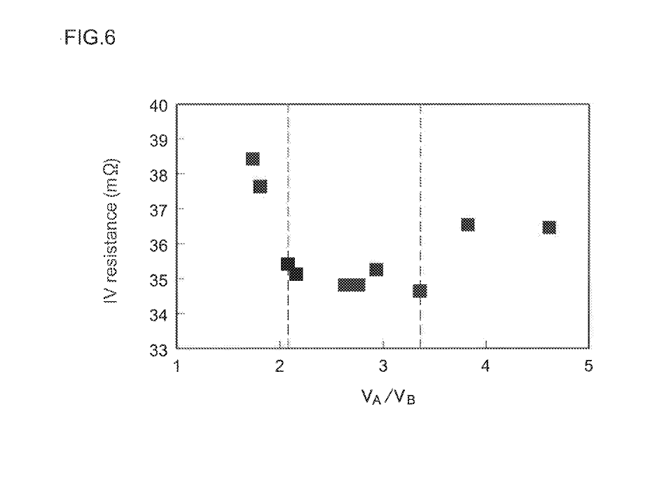

Then, for each battery fabricated as described above, the battery was adjusted to an SOC of 60% by constant-current/constant-voltage (CC-CV) charging at a temperature of 25° C. Discharge was then performed for 10 seconds at a current value of 10 C and the IV resistance was calculated from the voltage drop from the start of the discharge to after the 10 seconds. The results are shown in FIG. 6.

[Direct-Current Resistance Measurement]

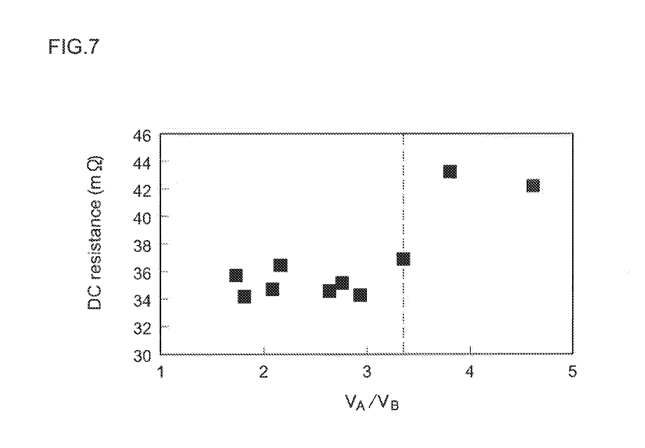

The direct-current resistance was measured under the following conditions using the alternating-current impedance measurement method. The direct-current resistance was determined by fitting the equivalent circuit for the resulting Cole-Cole plot (also known as a Nyquist plot). The results are given in FIG. 7.

instrumentation: “Model 1287 Potentiostat/Galvanostat” and “Model 1255B Frequency Response Analyzer (FRA)” from Solartron

measurement frequency: 10⁻² to 10⁵ Hz

measurement temperature: 25° C.

analytic software: ZPlot/CorrWare

As shown in FIG. 5, the high-temperature storage characteristics were poor at a small V_{A}/V_{B} (i.e., a large V_{B}), while excellent high-temperature storage characteristics were seen as V_{A}/V_{B} increased. This is thought to be due to the generation of irreversible capacity in association with growth of the SEI film on the surface of the negative electrode active material particles. Thus, it is thought that, because the specific surface area of the negative electrode active material becomes larger when V_{B} is large, the growth of the SEI film and the increase in the irreversible capacity become substantial.

Thus, it could be confirmed that, by setting the V_{A}/V_{B} determined from the negative electrode pore distribution to at least 2.1, a lithium secondary battery with a capacity ratio in the high-temperature storage test as high as at least 88% is obtained.

As shown in FIG. 6, the IV resistance at 25° C. for the battery was reduced when V_{A}/V_{B} was in the range from at least 2.1 to not more than 3.4. On the other hand, the IV resistance was relatively high when V_{A}/V_{B} was smaller than the indicated range (that is, a small V_{A} and/or a large V_{B}). The reason for this was thought to be that the lithium ion diffusion resistance within the composite material layer was increased due to the high density of the negative electrode composite material layer. Another reason was thought to be that the contact resistance between particles in the composite material layer was also increased due to growth of the low-electroconductivity SEI film as previously noted. In addition, a relatively high IV resistance is also shown when V_{A}/V_{B} is larger than the indicated range (i.e., a large V_{A}), and the reason here is thought to be that electroconductive pathways (electroconductive paths) have not been set up within the negative electrode composite material layer (or the electroconductive pathways have become narrow).

Thus, it could be confirmed that a lithium secondary battery having an IV resistance reduced to not more than 36 mΩ (that is, the product of the IV resistance (mΩ) at 25° C. and the battery capacity (Ah) is not more than 18 (mΩ·Ah)) is obtained by having the V_{A}/V_{B} determined from the negative electrode pore distribution be in the range from at least 2.1 to not more than 3.4. In addition, because the lithium ion diffusion resistance is restrained in this range, the use of the herein disclosed manufacturing method can produce a battery that also has excellent output properties.

As shown in FIG. 7, the direct-current resistance at 25 C of this battery was reduced when V_{A}/V_{B} was not more than 3.4. When, on the other hand, V_{A}/V_{B} was greater than 3.4 (i.e., a large V_{A}), the direct-current resistance exhibits a relatively large value, and the reason here is thought to be that electroconductive pathways (electroconductive paths) have not been set up within the negative electrode composite material layer as above.

Thus, it could be confirmed that a lithium secondary battery having a direct-current resistance reduced to not more than 40 mΩ (that is, the product of the direct-current resistance (mΩ) at 25° C. based on an alternating-current impedance measurement and the battery capacity (Ah) is not more than 20 (mΩ·Ah)) is obtained by having the V_{A}/V_{B} determined from the negative electrode pore distribution be not more than 3.4.

Based on the preceding results, a method for manufacturing a lithium secondary battery with excellent high-temperature storage characteristics and improved battery characteristics (for example, a reduced resistance) was demonstrated for a V_{A}/V_{B} of from at least 2.1 to not more than 3.4.

Specific examples of the present invention are particularly described in the preceding, but these are nothing more than examples and do not limit the claims. The art described in the claims encompasses various modifications of and variations on the specific examples provided above as examples.

### INDUSTRIAL APPLICABILITY

The herein disclosed lithium secondary battery can be used in a variety of applications, and is characterized by its excellent high-temperature storage characteristics and improved battery properties (for example, a reduced internal resistance). As a consequence, it can be favorably used, for example, as a power supply (drive power supply) for a motor mounted in a vehicle, e.g., an automobile. While the type of the vehicle is not particularly limited, it can be typically exemplified by plug-in hybrid vehicles (PHVs), hybrid vehicles (HVs), and electric vehicles (EVs).

### REFERENCE SIGNS LIST

1 automobile (vehicle)
10 positive electrode sheet (positive electrode)
12 positive electrode current collector
14 positive electrode composite material layer
20 negative electrode sheet (negative electrode)
22 negative electrode current collector
24 negative electrode composite material layer
40A, 40B separator sheet
50 battery case
52 case main body
54 lid
70 positive electrode terminal
72 negative electrode terminal
80 wound electrode assembly
100 lithium secondary battery

1. A method for manufacturing a lithium secondary battery,
the method comprising:
preparing a slurry negative electrode composite material layer-forming composition containing a negative electrode active material and a binder;
preparing a slurry positive electrode composite material layer-forming composition containing a positive electrode active material and a binder;
applying the negative electrode composite material layer-forming composition onto a negative electrode current collector to form a negative electrode that is provided with a negative electrode composite material layer on the negative electrode current collector;
applying the positive electrode composite material layer-forming composition onto a positive electrode current collector to form a positive electrode that is provided with a positive electrode composite material layer on the positive electrode current collector; and
fabricating a lithium secondary battery by using the negative electrode and the positive electrode, wherein
the negative electrode used to fabricate the lithium secondary battery has a maximum point, in accordance with measurement of pore distribution based on a mercury intrusion technique, in the pore diameter range (A) of from at least 0.3 μm to not more than 4 μm and in the pore diameter range (B) of from at least 0 μm to less than 0.3 μm, and has a ratio (V_{A}/V_{B}) between the pore volume (V_{A}) at the maximum point in the range A and the pore volume (V_{B}) at the maximum point in the range B of from at least 2.1 to not more than 3.4.

2. The method for manufacturing a lithium secondary battery according to claim 1, that forms a negative electrode that has a density for the negative electrode composite material layer of from at least 1.0 g/cm³ to not more than 1.6 g/cm³.

3. The method for manufacturing a lithium secondary battery according to claim 1, wherein a graphite is used as the negative electrode active material, the graphite having a cumulative 50% particle diameter (D₅₀) measured by a particle size distribution measurement (laser diffraction/light scattering technique) of from at least 3 μm to not more than 20 μm and having a specific surface area, measured by a nitrogen adsorption technique, of from at least 2 m²/g to not more than 40 m²/g.

4. The method for manufacturing a lithium secondary battery according to claim 1, wherein the negative electrode composite material layer-forming composition at least comprises a styrene-butadiene rubber and/or a carboxymethyl cellulose.

5. The method for manufacturing a lithium secondary battery according to claim 1, wherein the solids concentration in the negative electrode composite material layer-forming composition is from at least 40% to not more than 60%.

6. (canceled)

7. A lithium secondary battery provided with an electrode assembly having a positive electrode and a negative electrode, wherein
the negative electrode is provided with a negative electrode current collector and a negative electrode composite material layer formed on the negative electrode current collector;
the negative electrode composite material layer contains a negative electrode active material and a binder; and
the negative electrode composite material layer has a maximum point, in accordance with measurement of pore distribution based on a mercury intrusion technique, in the pore diameter range (A) of from at least 0.3 m to not more than 4 μm and in the pore diameter range (B) of from at least 0 μm to less than 0.3 μm, and has a ratio (V_{A}/V_{B}) between the pore volume (V_{A}) at the maximum point in the range A and the pore volume (V_{B}) at the maximum point in the range B of from at least 2.1 to not more than 3.4.

8. The lithium secondary battery according to claim 7, wherein the density of the negative electrode composite material layer is from at least 1.0 g/cm³ to not more than 1.6 g/cm³.

9. The lithium secondary battery according to claim 7, wherein the negative electrode active material is a graphite that has a cumulative 50% particle diameter (D₅₀) measured by a particle size distribution measurement (laser diffraction/light scattering technique) of from at least 3 μm to not more than 20 μm and has a specific surface area, measured by a nitrogen adsorption technique, of from at least 2 m²/g to not more than 40 m²/g.

10. The lithium secondary battery according to claim 7, wherein the negative electrode composite material layer-forming composition comprises a styrene-butadiene rubber and/or a carboxymethyl cellulose.

11. The lithium secondary battery according to claim 7, wherein the product of battery IV resistance (mΩ) at 25° C. and its battery capacity (Ah) is not more than 18 (mΩ·Ah) and the product of battery direct-current resistance (mΩ) at 25° C. based on an alternating-current impedance measurement and its battery capacity (Ah) is not more than 20 (mΩ·Ah).

12. A vehicle provided with a lithium secondary battery according to claim 7 as a drive power supply.
